(19) United States
(12) Patent Application Publication
(10) Pub. No.: US 2017/0248558 A1
(43) Pub. Date: Aug. 31, 2017

(54) CHROMATOGRAPHIC SYSTEM FOR RAPIDLY ISOLATING AND MEASURING A SINGLE OR MULTIPLE COMPONENTS IN A COMPLEX MATRIX

(71) Applicant: Falcon Alalytical Systems & Technology, Lewisburg, WV (US)

(72) Inventor: Ned Roques, Maxwelton, WV (US)

(73) Assignee: Falcon Alalytical Systems & Technology, Lewisburg, WV (US)

(21) Appl. No.: 15/443,848

(22) Filed: Feb. 27, 2017

Related U.S. Application Data
(63) Continuation of application No. 62/300,588, filed on Feb. 26, 2016.

(51) Int. Cl. G01N 30/46; G01N 30/60; G01N 30/30

(52) U.S. Cl. CPC G01N 30/461; G01N 30/30; G01N 30/6039; G01N 2030/3084; G01N 2030/025

(57) ABSTRACT

The disclosed chromatographic system enables sample slices to be moved back and forth between columns to rapidly isolate and measure a single or multiple components in a complex matrix. The independently controlled, two column system allows for the flow-recycling to take place since the sample slice can be effectively halted on either column until the second column is thermally ready to accept it again. The plumbing scheme also allows one to make an infinitely long column by being able to move components back and forth between the two by activating and deactivating the valve at the appropriate times.

### FIELD OF THE INVENTION

The invention discloses a chromatographic system using two columns and a flow-recycling pattern.

### BACKGROUND OF THE INVENTION

In chromatography, a mixture, vaporized in a carrier gas, is introduced into a column (packed, wall coated open tubular or porous layer open tubular) where differential migration of the compounds, through the column, results in their separation. The compounds take different times to travel the length of the column. Compounds having more affinity for the packing or liquid phase coating in the column will tend to be retained in the packing or liquid phase coating, and their migration through the column will take a longer time. However, as the number of compounds in the mixture increases, it becomes likely that two or more compounds will have similar affinities for the packing or liquid phase coating and, therefore, their migration times will become close to one another or almost identical. When this occurs, the compounds do not separate, and they will co-elute from the column. One of the ways that can be used to separate the co-eluted chemicals is re-injecting the non-separated compounds into a second chromatographic column as they elute from the first. In this “heart-cutting” technique, the flow of the first column is diverted into a second column temporarily at the elution time of the non-separated components. The chromatographic process continues on the second column which has a different packing or liquid phase coating, and separation can be achieved. In this technique that uses two gas chromatographs combined in series, the mixture has to be re-injected if another “heart-cut” is to be made in order to separate another region of the chromatogram.

In a prior art type of two-dimensional gas chromatography, generally referred to as heart-cutting, the first and second columns are two separate columns, with valves between them to permit diversion of vapor stream from the first column before it enters the second column. Generally, the mechanisms used to obtain separation of the components of the sample are similar in the two columns. In using prior art two-dimensional columns, one or more portions of sample eluting from the outlet port of the first column are diverted into the second column. Slices of eluted bands or one to several entire bands are injected into the second column where they are further separated prior to detection.

A disadvantage of the prior art systems is use of a pressure modulation type of sample diversion from one column to the next. Once a sample is passed from one column to the next, it can't be re-cycled back to the first column using this type of plumbing. A second disadvantage of using the pressure modulation type of sample diverters is that this plumbing scheme requires a small flow of diluting gas flow in order to drive the column effluent in the desired direction (i.e. either to a detector or to a second column inlet). This dilution of the chromatographic components can be detrimental to their detection if analyte quantities in the sample are low.

### SUMMARY OF THE INVENTION

A chromatographic system for isolating components of interest through repeated heart cuts has a microprocessor and a containment unit with an interior and an exterior. Within the interior of the containment unit are two columns, each having an input and an output and in communication with the microprocessor. The two columns are temperature controlled independently through the microprocessor. Also within the unit is at least one detector, in communication with the microprocessor. An inlet for receiving components extends from the interior of the containment unit to the exterior to receive the components. A thermally insulated isothermal oven, in communication with the microprocessor, contains at least one flow restrictor and a CS valve having multiple port pairs, each which has an input port and an output port. Tubing, having a length and an interior diameter, is used for fluid communication within the containment unit and isothermal oven.

Fluid communication within the containment is indirect between the elements and direct between the elements and the CS valve. The inlet is in direct communication with one of the CS valve input ports; and enabling fluid communication with the input and output of the first and second columns as well as the flow restrictor. The flow restrictor is in direct fluid communication with each of the detectors and is an intermediary between the detectors and the CS valve. When a second detector is used a second flow restrictor is also incorporated. A second tee is placed in direct fluid communication with an output port of the CS valve and each of the flow restrictors divides the flow components to the detectors.

In the preferred embodiment the system has a pre-column in direct fluid communication with the inlet and the input port of one of said multiple port pairs of said CS valve. Preferably the system has a 3-way solenoid in communication with the microprocessor and having three ports. The first of the ports is in direct fluid communication with the inlet, a second of the ports is in direct fluid communication with one of the port pairs input ports, and a third of the ports is in fluid communication with a gas source. The first and second of the ports open and close based on input from the microprocessor while the third port remains open during operation. When a 3-way solenoid is being used a tee connector is placed in direct fluid communication with the pre-column, the CS valve, and the 3-way solenoid.

In the CS valve of the chromatographic system one of said multiple port pairs preferably has an input port in fluid communication with said inlet and an outlet port in communication with said inlet of a first of said columns; another of said multiple port pairs preferably has an input port in fluid communication with said inlet of a second column and an outlet port in fluid communication with said outlet of said first column; and another of said multiple port pairs preferably has an input port in fluid communication with said outlet of said second column and an outlet port in fluid communication with each of said at least one flow restrictor.

Tubing is used to provide the fluid communication with the length and interior diameter of the tubing controlling flow of the components and the gas.

### BRIEF DESCRIPTION OF THE DRAWINGS

The objects, features, advantages and aspects of the present invention can be better understood with reference to the following detailed description of the preferred embodiments when read in conjunction with the appended drawing figures.

FIG. 1 is an example plan view of the two column system with the column switching valve in the idle state, in accordance with the invention;

FIG. 2 is an example plan view of the two column system with the column switching valve in the active state, in accordance with the invention;

FIG. 3 is an example plan view of the two column system in the idle state with a second detector in accordance with the invention;

FIG. 4 is an example plan view of the two column system in the active state with a second detector; in accordance with the invention; and,

FIG. 5 is an example plan view of an additional embodiment of the column system in accordance with the invention

### GLOSSARY

| | |
|---|---|
| 10 | chromatographic system |
| 12 | First column |
| 14 | Second column |
| 16 | Detector |
| 20 | Isothermal oven |
| 22 | Pre-column |
| 24 | Inlet |
| 26 | Flow restrictor |
| 28 | Tee |
| 30 | 3-way solenoid valve |
| 32 | Backflush port |
| 34 | Injection port |
| 36 | Gas inlet port |
| 40 | CS Valve |
| Position A | Idle state |
| Position B | Active state |
| 42 | Column 12 inlet |
| 50 | Column 14 inlet |
| 52 | Column 14 outlet |
| 54 | Column 12 outlet |
| 110 | chromatographic system |
| 112 | First column |
| 114 | Second column |
| 116 | Detector |
| 118 | detector |
| 120 | Isothermal oven |
| 122 | Pre-column |
| 124 | Inlet |
| 126 | Flow restrictor |
| 128 | Tee |
| 130 | 3-way solenoid valve |
| 132 | Backflush port |
| 134 | Injection port |
| 136 | Gas inlet port |
| 140 | CS Valve |
| Position 1A | Idle state |
| Position 1B | Active state |
| 142 | Column 112 inlet |
| 150 | Column 114 outlet |
| 152 | Column 114 outlet |
| 154 | Column 112 outlet |
| 156 | tee |

### DETAILED DESCRIPTION OF THE INVENTION

### Definitions

As used herein the term “about” shall refer to a range of +/−15%.

As used herein the term “heart-cutting” shall refer to a technique where only a fraction of eluent is transferred (“cut”) from the primary analytical column onto the second analytical column.

As used herein the term “low-recycling” and “flow-recycle”, shall refer to multiple transferring, or recycling, of the sample from one column to another.

The prior art systems use a pressure modulation type of sample diversion from one column to the next. Once a sample is passed from one column to the next, it cannot be re-cycled back to the first column. The disclosed system enables sample slices to be repeatedly moved back and forth between columns. The independently controlled, two column system allows for the flow-recycling to take place since the sample slice can be effectively halted on either column until the second column is thermally ready to accept it again. The plumbing scheme also allows a user to make the equivalent of an infinitely long column by being able to move components back and forth between the two by activating and deactivating the valve at the appropriate times.

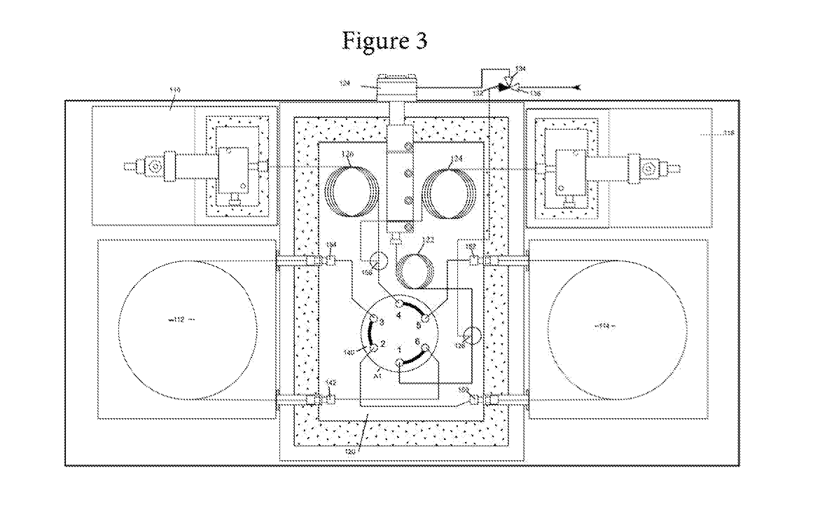

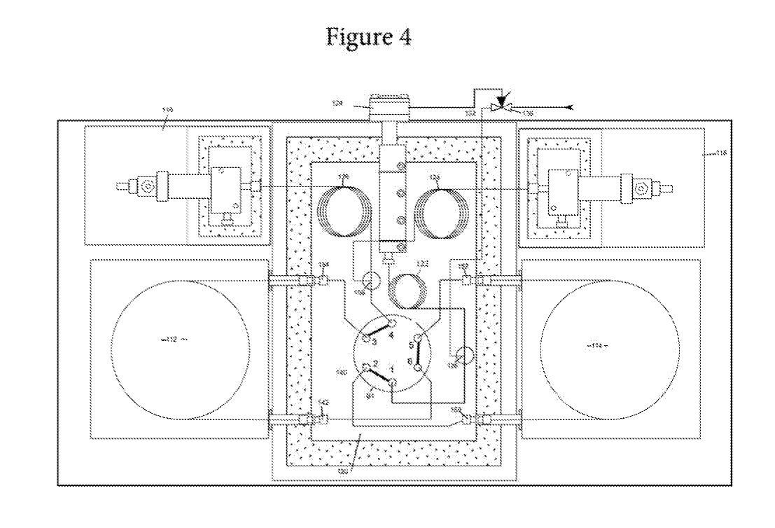

The disclosed system further permits much wider heart cuts than the prior art systems, with heart cuts decreasing in width with each transfer between columns. Prior art systems generally have a maximum of 5 sec heart cuts to help avoid co-elution of the component of interest with other compounds on the second column. For example, the first heart-cut to the second column could be very wide (e.g. >15 s), followed by a second heart-cut from the second column back to the first column being much smaller (e.g. <5 s). An even smaller third heart-cut (e.g. <2 s), if necessary, can be transferred back to the second column. The transfers can be repeated multiple times until the band broadened component volume exceeds the volume of either separation column. Only one detector is required for this system in most applications and the output of either column can be diverted to the single detector. In applications where it is desirable, or necessary, two detectors can be used and the plumbing would generally be such that the output to both detectors is split from a common tube coming from the effluent of either column depending on the state of the column switching valve. An example arrangement using two restrictors is illustrated in FIGS. 3 and 4.

The disclosed invention allows the separation and quantification of single or multiple components in a complex sample using two separate, independently temperature controlled, chromatographic columns. The disclosed system enables multiple heart-cut events and therefore multiple exchanges between the columns. The system further allows for the repeated re-injecting and, if necessary, re-focusing of the component(s) of interest back and forth between the two chromatographic columns until adequate separation is achieved for quantitation.

Rather than a single, long separation column, two short (for example about 10 m or less) separation columns of the same type can be used. Alternatively the columns can have different lengths, internal diameters, stationary phases or packings, and stationary phase thicknesses can be used and tuned for optimal separation characteristics (fastest time to achieve desired separation) dependent upon the component(s) of interest.

Having two independent, temperature controlled separation columns allows a component(s) of interest to be thermally driven off of an initial separation column into a secondary, cool separation column via a heart-cut event, where the component(s) of interest can be re-focused if the retention factor of the component(s) of interest is high enough to support re-focusing on the stationary phase or packing of the separation column.

Because of the flow-recycling plumbing system, the component(s) of interest can be refocused and heart-cut repeatedly between the two separation columns in smaller and smaller bands, quickly reducing the quantity and magnitude of interfering components. This allows for a large volume of sample to be introduced into the chromatographic system in order for low levels of detection (<100 ppb) to be achieved for the component of interest.

In the disclosed system, any remaining difficult-to-separate, interfering components can be separated due to the ability to flow-recycle the sample. Once the bulk of the interfering components has been removed from the system, both separation columns can be used as an infinitely long separation column by temperature programming both slowly together or holding each isothermally at an optimal separation temperature and heart cutting the component(s) of interest back and forth between the two until a desired separation is achieved.

Once enough interfering components have been removed for adequate final separation of the component of interest on either column, one last re-focusing can be performed followed by a fast temperature program of the separation column in order to drive the component(s) of interest out of the separation column in the narrowest band possible to the detector for maximum signal generation thus increasing the signal to noise ratio further.

All heaters (including detector heaters, isothermal oven heaters and column 12, 14, 112 and 114 heaters), temperature program cycles for both columns, and timed events that activate the CS valve, 3-way valve, sample loop injection valve and data acquisition from detectors are microprocessor controlled. The microprocessor control can be from a single microprocessor that manages all of the above listed activities, or several microprocessors, handling individualized activities, networked together and time-synchronized at the start of each analysis cycle. The disclosed system can also be a modular component in a larger system with a predetermined number of microprocessors running this system or it can be tied into the microprocessor running a larger system. The modular process is disclosed in detail in U.S. Pat. No. 8,336,366 which is incorporated herein as though recited in full.

The software is a custom designed suite that works in conjunction with a commercially available chromatography package called ChromPerfect. The CS valve switching is controlled by “timed events” that are input by the user into a parameter file that gets downloaded to the system's microprocessor. At the start of an analysis the microprocessor executes the timed events chronologically as On/Off pairs (“On” being position B of the CS valve 40, 140 and “Off” being position A) timed from the start of the analysis. Depending on the program being used, the CS valve 40, 140 position A, A11 and position B, B1 can be diverted using the microprocessor in order to direct flow.

The CS valve controls the fluid communication between the remaining elements. There is direct flow from each element to the CS valve and fluid communication between the elements is considered herein as being indirect as it must pass through the CS valve.

The tees used within the example system 10, 100 are passive connectors, basically three holes that meet in the middle. The direction of the flow to the tee is controlled by pressure from the CS valve 40, 140. The flow restrictors attached at the outputs of the tee passively control the flow through each based on the flow restriction “value” of each tube (i.e. length and inside diameter). By changing one or more tubes, the flow of gas and components to the elements within the system 10, 100 can be changed. The appropriate combination of tube length and interior diameter can vary from application to application and the dimensions required for a specific application will be known to those skilled in the art.

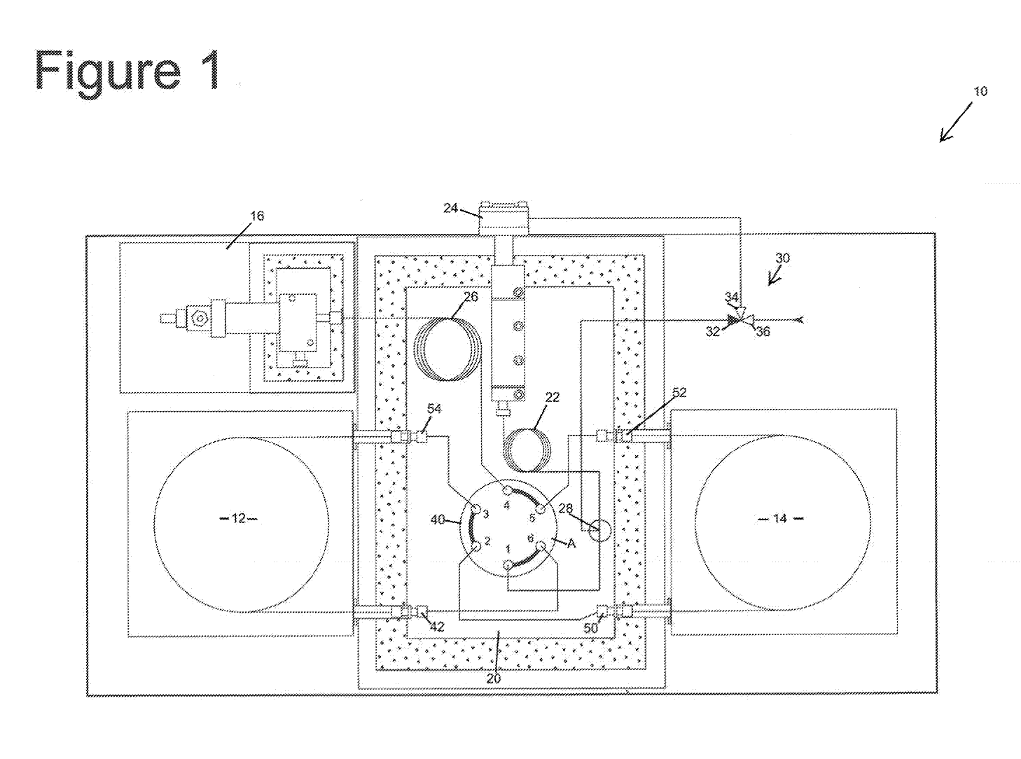

An example of customizing the tubing, in this example the tubes exiting the CS Valve at port 6 to column 12 input (42, 142, 242) and port 2 to column 14 input (50, 150, 250) as disclosed hereinafter in description of FIGS. 1-5. In the case where the gaseous volume of the band of the component(s) of interest increases, due to diffusion after multiple heart cuts, to the point where it's larger than the internal volume of either column, the tubes can be lengthened in order to create a “buffer” volume in order to prevent the component band volume from “overflowing” the column that is being heart-cut to.

In some applications it can be advantageous to replace the passive tee connectors illustrated with additional multiport CS valves, or other valves, to direct flow. Any valve used must be designed for chromatographic use, i.e., inert internal pathways, low internal pathway volume, ability to withstand high temperatures >150 C, small enough to reasonably fit into a chromatographic oven, ability to switch the valve quickly <100 ms. The applications where this will be beneficial will be recognized by those skilled in the art as will the appropriate valves.

The flow-recycling plumbing system also allows the investigator to choose which column the sample is initially injected into, making the system more flexible and accommodating of different sample types and matrices. The selection of the column depends on the component of interest and the matrix that it is mixed with. The polarity of one column may be better suited (separates the component of interest from a maximum number of interfering components) for making a first heart-cut to the second column of a different polarity. If a sample containing a different matrix and component of interest needs to be analyzed on the same system, the column having the opposite polarity from the first could be injected to if it provides for a more efficient first heart-cut without the need to physically re-plumb the instrument.

The use of a pre-column and tee between the inlet and column switching (CS) valve along with a 3-way solenoid valve creates a low molecular weight “pass” filter to prevent unwanted heavy components from entering the columns, thus eliminating the requirement to heat the columns to higher temperatures in order clean them out. This saves valuable time in the column cool-down portions of the cycle. The 3-way solenoid valve can be switched to a mode whereby carrier gas is diverted from the inlet to the tee which will backflush and clean the pre-column during the remaining analysis time. The pre-column and 3-way valve can be eliminated depending on the sample matrix and whether or not to include these elements will be known to those in the art. The 3 way solenoid valve can be pneumatically or electromechanically operated. It should be noted that the layout of the system as illustrated in FIGS. 1-4 are for example only and the contents can be positioned as convenient for manufacture.

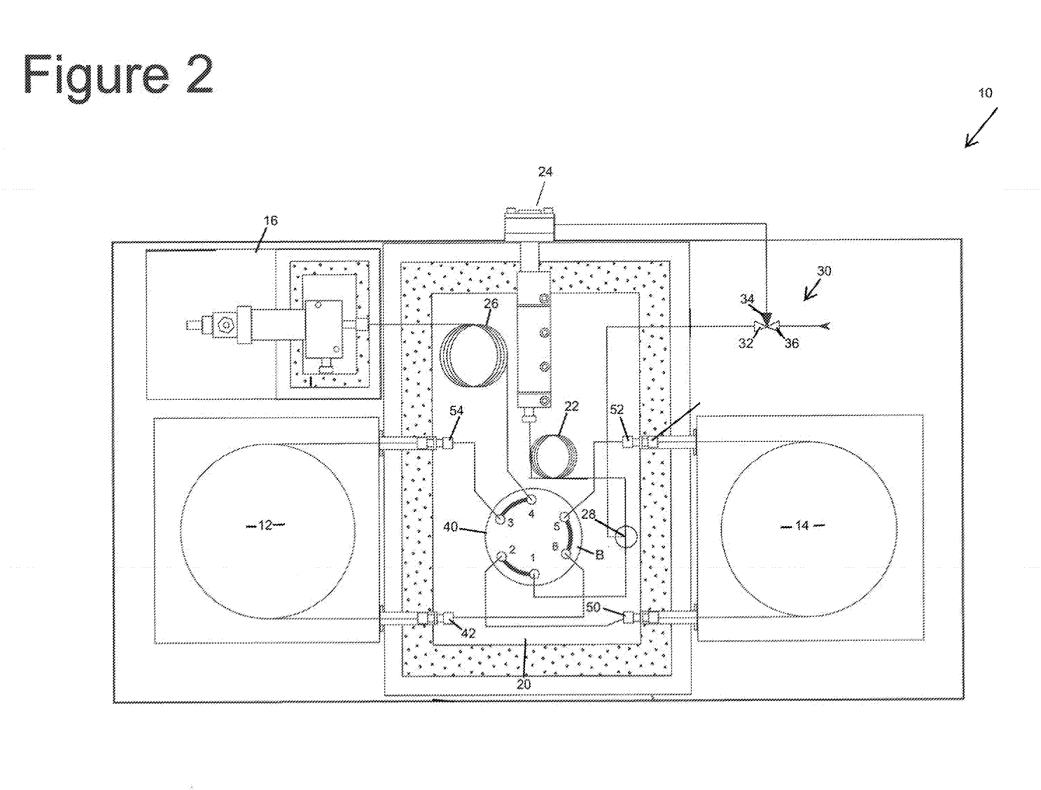

As illustrated in FIGS. 1 and 2, the basic components of the chromatographic system 10 consist of an isothermal oven 20, a first column 12, second column 14 and detector 16.

The isothermal oven 20 is an insulated, temperature controlled zone where mechanical components reside at an elevated temperature in order to prevent the condensation of sample in the associated flow paths that comprise the system.

Within the isothermal oven 20 is the pre-column 22 that can be any chromatographic separation column, capillary or packed, that contains a stationary phase or packing that interacts with the injected sample enough to create a molecular “filter”. The molecular filter serves to prevent unwanted high molecular weight components from reaching either separation column 12 or 14. The pre-column 22 must be able to withstand the temperatures in the Isothermal Oven 20 continuously and provide the required filtering effect. The pre-column 22 is only connected to the chromatographic system 10 between the inlet 24 and the tee 28. The tubing between the tee 28 and Port 1 of the CS valve 40 is plain deactivated tubing of either fused silica or stainless steel internally coated by any available deactivation process (e.g. Silcotek's Sulfinert, Silcosteel, etc.). The tubing from the inlet 24 to the tee 28 forms the pre-column “filter” which is basically a short length of any type of column material suited for the temperature and sample filtering requirements. Since each application is different, slightly different materials can be required for the tubing which will be known to those skilled in the art. The tee 28 is a coated and deactivated (same Silcotek process) stainless steel tee.

An inlet 24, a split/splitless type chromatographic injector, a sample loop injection valve, or any equivalent that will meet the disclosed requirements, is used to inject gas or liquid phase samples automatically. Alternatively, a split/splitless injector with a sample loop injection valve attached to the top of the input port of the injector can be used.

The column switching (CS) valve 40, as illustrated herein, is a multi-port, two position chromatographic valve with at least, but not limited to, 6 ports. In FIG. 1 the valve is in position A reflecting the idle state and in FIG. 2, position B reflecting the active state. The valve can be of the rotary or diaphragm variety and can be actuated by any electric motor (servo or stepper) or rotary pneumatic driver, both commercially available. The motor should have the ability to actuate the valve 40 through its full range of motion (from position 1 to position 2 or vice versa) in less than 100 ms. The CS valve 40 controls the flow of the sample within the system 10 based upon the position of the valve 40, as described in more detail hereinafter.

The flow restrictor 26 is a deactivated capillary tube or fritted fitting capable of providing back pressure to the outlet 54 the first column 12 or outlet 52 of the second column 14, depending on the position of the CS valve 40. Due to the short nature of the columns used, the Flow Restrictor 26 allows for an increase in the overall system pressure for easier control while maintaining the proper linear velocity in the separation columns 12 and 14 for maximum separating efficiency.

The tee 28 is a simple three connection fitting that is preferably deactivated to prevent sample adsorption or catalytic reaction on the metal surface.

The detector 16 can be any chromatographic detector well known in the art, such as: Flame Ionization Detector (FID), Thermal Conductivity Detector (TCD), Flame Photometric Detector (FPD), Dielectric Barrier Discharge Detector (DBD), Photo Ionization Detector (PID), Pulsed Discharge Detector (PDD), Mass Spectrometer Detector (MSD), Sulfur Chemiluminescence Detector (SCD) or Pulsed Flame Photometric (PFPD). Although a single detector is illustrated in FIGS. 1 and 2, a second detector can also be connected to the system as illustrated in FIGS. 3 and 4 via a tee at the output of the valve that contains the Flow Restrictor 26.

Column 12 is a chromatographic separation column, capillary or packed, located in a self contained module or oven that can be independently temperature programmed and cooled while remaining thermally isolated while remaining in fluid communication with components located in the Isothermal Oven 20. The column 12 is usually, but not limited to, 10 meters or less in length. The column 12 can be identical to the second column 14 or have a different internal diameter, stationary phase, packing material, and/or length.

Column 14 is a chromatographic separation column, capillary or packed, located in a self-contained module or oven that can be independently temperature programmed and cooled while remaining thermally isolated while in fluid communication with components located in the Isothermal Oven 20. The column 14 is usually, but not limited to, 10 meters or less in length. The column can be identical to Column 12 or have a different internal diameter, stationary phase, packing material, and/or length.

The 3-way solenoid valve 30 is an electromechanically or pneumatically actuated valve having three ports; backflush port 32, injection port 34 and gas inlet port 36. As illustrated in FIG. 1, port 34 is open during use to permit carrier gas from gas inlet port 36 to enter the system. During the backflush state, port 34 would be closed and port 32 opened.

As illustrated in the example layouts of FIGS. 3 and 4, the basic components are the same as illustrated in FIGS. 1 and 2. The chromatographic system 100 consist of an isothermal oven 120, a first column 112, and second column 114. In this embodiment, two detectors 116 and 118 are used that, although not generally required, are applicable in some applications. As illustrated in FIGS. 3 and 4, the detectors 116 and 118 are located within the system 100 above the columns 112 and 114 respectively.

As with the previously described embodiment, the sample is inserted at inlet 124 where it travels to the pre-column 122 and on to the tee valve 128 and into the CS valve 140. The separation process, using the column 112 inlet 142, column 114 inlet 150, column 112 outlet 154 and column 114 outlet 152 process of heart-cutting as described. The states of the CS valves 140, switch from idle state position 1A to active state position 1B as noted herein. The 3 way solenoid 130 operates the same as in the embodiment of FIGS. 1 and 2, opening and closing the backflush port 132 and injection port 134 as necessary while the gas inlet port 136 remains open.

As shown in FIG. 4, after leaving the CS valve 140, an additional tee 156 can be added to the line leaving the flow restrictor 126 to divert flow to a second flow restrictor 124 leading into the second detector 118.

A second detector is valuable when a single detector cannot detect all components of interest due to analyte concentration differences or if a detector has limited or no response to a component of interest. For example, a thermal conductivity detector (TCD) will respond to all components but is not very sensitive, so it is a good candidate for high concentration components or non-hydrocarbon analytes (e.g. oxygen, carbon dioxide, and other permanent gases), whereas the flame ionization detector (FID) is a very sensitive detector but only responds to hydrocarbons. Those skilled in the art understand these differences and utilize different and multiple detectors routinely. Both detectors in the scheme described here would be used simultaneously.

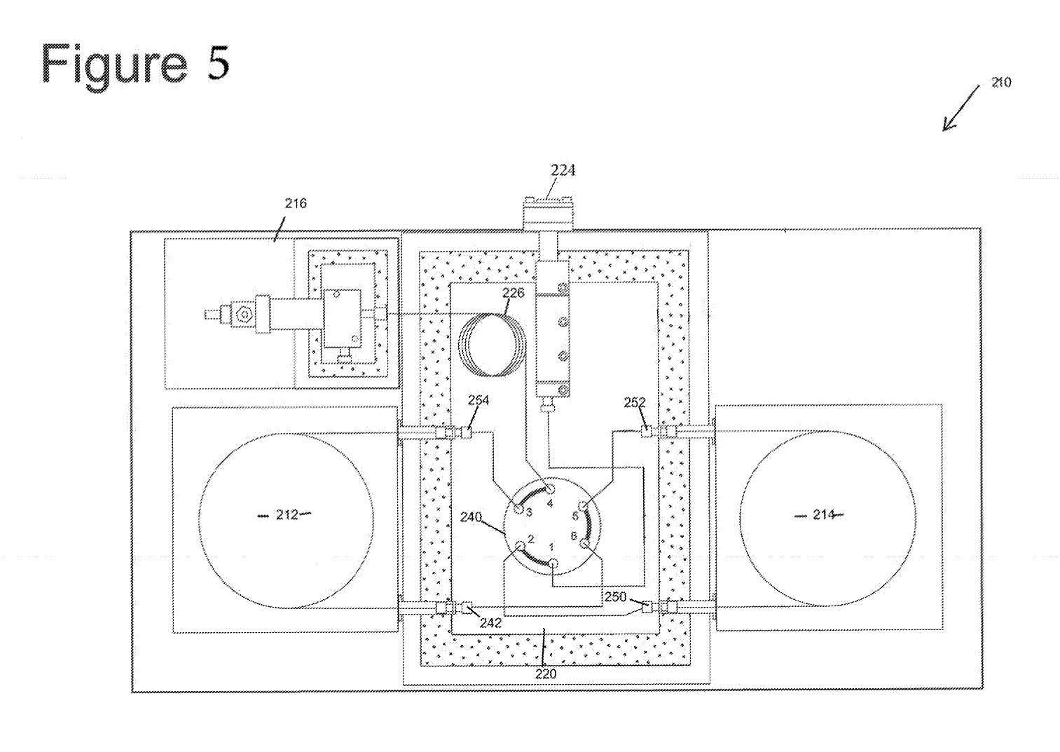

In FIG. 5, the system 210 contains the inlet 224 to receive the sample, however in this embodiment the sample travels directly to the CS valve 240. The separation process, using the column 212 inlet 242, column 214 inlet 250, column 212 outlet 254 and column 214 outlet 252 process of heart-cutting as described. The states of the CS valves 140, switch from idle state position 1A to active state position 1B as noted herein, with the active state being illustrated. The 3-way solenoid has also been eliminated along with the tee 28 of FIGS. 1, 3 and 2, 4. The system flow through the gas line comes directly from the inlet 224.

In this alternate embodiment, the system 210 functions properly without the pre-column, 3-way valve and tee, however it takes longer to flush higher molecular weight components from the column to which the sample was initially injected since the backflush to vent was eliminated. The pre-column in this embodiment would be replaced with a short, regular deactivated tube.

Example of Operation

In this example a complex sample containing a single component of interest is injected onto Column 12, 112 for descriptive clarity only. Either column 12, 112 or 14, 114, can be used for initial injection or multiple components of interest, vs the single used within this example, can be resolved.

The complex sample is injected into the pre-column 22, 122, at the inlet 24, 124 using a split/splitless injector, a sample loop injection valve or a split/splitless injector with a sample loop injection valve. The inlet 24, 124 is coupled to the tee 28, 128 through the pre-column 22, 122 to ensure that all samples pass through the pre-column 22, 122, prior to entering the CS valve 40, 140 at port 1.

The CS Valve 40 is initially in the position A, A1 “Idle State” as illustrated in FIGS. 1 and 3 and the 3-Way Solenoid valve 30 is in the “Inject State” with port 34, 134 open. With the CS valve 40, 140 in its idle state (position A, A1), the output of the tee 28, 128 drives the flow into port 1 and out port 6 to the input 42, 142 of column 12, 112.

When the component of interest has fully eluted from the Pre-Column 22, 122 to Column 12, 112 the CS Valve 40, 140 is switched to position B,1B, its “Active State” as illustrated in FIGS. 2 and 4, and backflush port 32, 134 of the 3-Way Valve 30, 130 opened to the “Backflush State”. When the CS valve is switched to position B, the output of the tee 28 is connected, via the CS Valve from port 1 to 2, and into the input of column 14. The output of column 14 is also now connected, via the CS Valve from port 5 to 6, to the input of column 12. The carrier gas in the system is always flowing, whether or not sample has been injected so therefore the output flow/pressure from column 14 is driving flow to the input to column 12. The component of interest is re-focused (condensed) at the input section 42,142 of Column 12, 112 while lighter molecules in the sample matrix have begun to elute from the output 54, 154 of the Column 12, 112 to port 3 on the CS valve 40, 140 and out at port 4 to the flow restrictor 26, 126, 226.

The system 10, 100 switches from position A, A1 to B, B1 and vice versa, based on the user experimenting with multiple injections of a sample or external standard containing the component(s) of interest and observing the time of elution of the component(s) of interest from each column to the detector. These observed times are input into a table in the software in On/Off pairs after which they are executed automatically by the microprocessor from the start of an analysis. There can be multiple timed-event pairs, with the timing of each being determined through experimentation by the user to ensure that the component(s) of interest are successfully moved from one column to the next at the appropriate time until it's deemed time to direct it out to the detector(s) for quantitation.

At this point the operation between the embodiment of FIGS. 1 and 2 differs from that of FIGS. 3 and 4. In the embodiment having a single detector, the output of port 4 goes directly to the Flow Restrictor 26 and on to Detector 16. In the embodiment of Figurers 3 and 4, the output from port 4 travels to tee 156 where it is redirected to both flow restrictors 126 and 126 and on to both detectors 116 and 118 simultaneously.

Column 12, 112 now begins to heat while Column 14, 114 remains cool.

At the predetermined time, based on the experimentation noted above, the elution of the component of interest, the CS Valve 40, 140 is switched back to position A, A1 of FIGS. 1 and 3 momentarily. This will temporarily connect the output 54, 154 of Column 12, 112 to the input 50, 150 of Column 14, 114 through CS valve 40, 140 port 3 and port 2. This allows a slice from the separated complex sample containing the component of interest to be moved and re-focused at the input 50, 150 to Column 14, 114.

With the CS Valve 40, 140 back in the position B, B1 “Active State” (FIGS. 2 and 4), the Column 12, 112 continues heating until Column 12, 112 is cleaned of the remaining heavier components.

When Column 12, 112 has finished heating and cleaning out and has cooled to a temperature that is sufficient to re-focus the component of interest back on Column 12, 112, the CS Valve 40, 140 is switched to the “Idle State” and Column 14, 114 begins its temperature program.

At a second predetermined time from Column 14, 114, the CS Valve 40, 140 is switched back to its position B, B1 “Active State” momentarily, in order to move a second, even more separated slice containing the component of interest back to the input 42, 142 of Column 12, 112 where it is again re-focused.

With the component of interest stationary on Column 12, 112 and the CS Valve 40, 140 in its position A, A1 “Idle State”, Column 14, 114 continues its temperature program until the remaining unwanted heavy components have eluted the column 14, 114. The column 14, 114 is then cooled to a temperature that will once again re-focus the component of interest or can remain hot at a temperature that will provide for maximum separation of the remaining interfering components from the component of interest.

If more “heart-cutting” of the component of interest is needed, the CS Valve 40, 140 can be switched to position B. B1, and another temperature program can be initiated. An even smaller heart-cut can be taken around the component of interest by switching the CS Valve 40, 140 momentarily to the position A, A1 “Idle State”, and then re-focusing it on Column 14, 114 or if Column 14, 114 is at an elevated temperature that supports the maximum separation of the component of interest from interfering components, it can move through the output 52, 152 of column 14, 114 to CS valve 40, 140 port 5 and to the Detector 16, 116 through port 4 for quantitation. As noted above, if a second detector 118 is being used, the components would move from port 5 to the tee 156 and on to both detectors simultaneously.

At this point it should be obvious that the component of interest could be moved back and forth between the two columns indefinitely, provided the band width volume of the component of interest doesn't exceed the internal volume of either column 12 or 14, using the above sequence, if so desired without dilution or a loss of material.

Once it is determined that enough “heart-cutting” has been performed between the columns 12, 112 and 14, 114 to sufficiently separate the component of interest from other interfering components, several strategies can be employed to perform a final elution to the Detector(s). Some of these include:

A slow ramp of the column 12, 112 containing the re-focused component of interest connected in series to the second column 14,114, also ramping slowly, with the final elution to the detector 16, 116 or 118, from the second column 14, 114. Alternatively the component of interest can be put back into the first column 12, 112 for more separation and then to the second column 14, 114, then the first 12,112, repeated, until finally sent to the Detector(s) 16, 116 or 118 for quantitation.

Another approach could be to heat the column 12, 112 containing the component of interest as fast as possible in order to drive the component off of the column 12, 112 in the narrowest possible band to maximize the signal to noise ratio at the Detector(s) 16, 116 or 118. The fast driving of the component of interest from either column 12, 112 or 14, 114 could then be followed by movement to the opposite column for a quick isothermal separation followed by diversion to the Detector(s) 16, 116 or 118 for quantitation or once again back to the first column 1, 1122 for more separation at a predetermined isothermal temperature, repeated, until finally sent to the Detector(s) 16, 116 or 118 for quantitation.

Before the final elution to the Detector(s) 16, 116 or 118, either column 12, 112 or 14, 114 could be heated to a high enough temperature that the component of interest and any interfering components no longer interact with the stationary phase or packing of the column. This is useful if only one of the columns are desired to perform the final separation using a slow temperature ramp or isothermal temperature in a looped re-cycle mode.

To close out the analysis the 3-Way Valve 30, 130 is switched back to its “Inject State”.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language of the present invention or inventions should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

While in the foregoing embodiments of the invention have been disclosed in considerable detail, it will be understood by those skilled in the art that many of these details may be varied without departing from the spirit and scope of the invention.

What is claimed is:

1. A chromatographic system for isolating components of interest having:
a. a microprocessor,
b. a containment unit, said containment unit having an interior and an exterior, and having within said interior:
a first column, said first column having an input and an output and in communication with said microprocessor,
a second column, said second column having an input and an output and in communication with said microprocessor and in indirect fluid communication with said input and said output of said first column,
at least one detector, said at least one detector being in communication with said microprocessor, and in indirect fluid communication with said output of said first column and said output of said second column,
an inlet for receiving components, said inlet extending from said interior of said containment unit to said exterior of said containment unit to receive said components and in indirect fluid communication with said first column and said second column,
an isothermal oven, said isothermal oven being thermally insulated and having an interior and an exterior, and in communication with said microprocessor and fluid communication with input and said output of said first column, said input and said output of said second column and each of said at least one detector, and containing:
at least one flow restrictor, each of said at least one flow restrictor being in direct fluid communication with one of said at least one detectors
a CS valve, said CS valve having multiple port pairs, each of said multiple port pairs having an input port and an output port, and being in direct fluid communication with said input and said output of said first column, said input and said output of said second column, each of said at least one flow restrictor, and said inlet,
tubing, said tubing having a length and an interior diameter and enabling fluid communication.

2. The chromatographic system of claim 1 further comprising a pre-column, said pre-column being in direct fluid communication with said inlet and said input port of one of said multiple port pairs of said CS valve.

3. The chromatographic system of claim 1 further comprising a 3-way solenoid, said 3-way solenoid being in communication with said microprocessor and having three ports.

4. The chromatographic system of claim 3 wherein a first of said ports is in direct fluid communication with said inlet, a second of said ports is in direct fluid communication with one of said input ports of said port pairs and a third of said ports is in fluid communication with a gas source.

5. The chromatographic system of claim 3 wherein the first of said ports and the second of said ports open and close based on input from said microprocessor.

6. The chromatographic system of claim 3 wherein the third of said ports remains open during operation.

7. The chromatographic system of claim 3 wherein said 3-way solenoid is on said exterior of said containment unit.

8. The chromatographic system of claim 3 wherein said 3-way solenoid is within said interior of said containment unit.

9. The chromatographic system of claim 1 further comprising:
a pre-column, said pre-column being in direct fluid communication with said inlet and one of said input ports of said multiple port pairs of said CS valve.

10. The chromatographic system of claim 1 further comprising:
a 3-way solenoid, said 3-way solenoid having a first of said ports in direct fluid communication with said inlet, a second of said ports in direct fluid communication with one of said input ports of said port pairs, and a third of said ports in fluid communication with a gas source; the first of said ports and the second of said ports open and close based on input from said microprocessor.

11. The chromatographic system of claim 10 further comprising:
a. a first tee connector, said first tee connector being in direct fluid communication with said pre-column, said CS valve and said 3-way solenoid

12. The chromatographic system of claim 1 further comprising:
a. a pre-column, said pre-column being in direct fluid communication with said inlet and one of said input ports of said multiple port pairs of said CS valve.
b. a 3-way solenoid, said 3-way solenoid having a first of said ports in direct fluid communication with said inlet, a second of said ports in direct fluid communication with one of said input ports of said port pairs, and a third of said ports in fluid communication with a gas source, the first of said ports and the second of said ports open and close based on input from said microprocessor.
c. a first tee connector, said tee connector being in direct fluid communication with said pre-column, said CS valve, and said 3-way solenoid

13. The chromatographic system of claim 11 further comprising a second tee connector, said second tee connector being in direct fluid communication with an output port in said CS valve and each of said flow restrictors, said second tee dividing said components to each of said at least one flow restrictor.

14. The chromatographic system of claim 1 wherein in said CS valve one of said multiple port pairs has an input port in fluid communication with said inlet and an outlet port in communication with said inlet of a first of said columns; another of said multiple port pairs has an input port in fluid communication with said inlet of a second column and an outlet port in fluid communication with said outlet of said first column; and another of said multiple port pairs has an input port in fluid communication with said outlet of said second column and an outlet port in fluid communication with each of said at least one flow restrictor.

15. The chromatographic system of claim 1 wherein length and interior diameter of said tubing controls flow of said components and said gas.

16. The chromatographic system of claim 1 wherein said first column and said second column are independently programmed for temperature through said microprocessor.

17. A chromatographic system for isolating components having:
a. a microprocessor,
b. a containment unit, said containment unit having an interior and an exterior, and having within said interior:
a first column, said first column having an input and an output and in communication with said microprocessor,
a second column, said second column having an input and an output and in communication with said microprocessor and in indirect fluid communication with said input and said output of said first column,
at least one detector, said at least one detector being in communication with said microprocessor, and in indirect fluid communication with said output of said first column and said output of said second column,
an inlet for receiving components, said inlet extending from said interior of said containment unit to said exterior of said containment unit to receive said components and being in indirect fluid communication with said first column and said second column,
an isothermal oven, said isothermal oven being thermally insulated and having an interior and an exterior, and in communication with said microprocessor and fluid communication with said first column said second column and each of said at least one detector, and containing:
a CS valve, said CS valve having multiple port pairs, one of said multiple port pairs has an input port in fluid communication with said inlet and an outlet port in communication with said inlet of a first of said columns; another of said multiple port pairs has an input port in fluid communication with said inlet of a second column and an outlet port in fluid communication with said outlet of said first column; and another of said multiple port pairs has an input port in fluid communication with said outlet of said second column and an outlet port in fluid communication with each of said at least one flow restrictor,
at least one flow restrictor, each of said at least one flow restrictor being in direct fluid communication with an output port in said CS valve and one of said at least one detectors;
a pre-column, said pre-column being in direct fluid communication with said component inlet and input port of one of said multiple port pairs of said CS valve;
a first tee connector, said first tee connector being in direct fluid communication with said pre-column, said CS valve and said 3-way solenoid,
tubing, said tubing having a length and an interior diameter and enable fluid communication, said length and interior diameter controlling flow of said components and said gas;
c. a 3-way solenoid, said 3-way solenoid being in communication with said microprocessor and having three ports, a first of said ports is in direct fluid communication with said inlet, a second of said ports is in direct fluid communication with one of said input ports of said port pairs and a third of said ports is in fluid communication with a gas source and the first of said ports and the second of said ports open and close based on input from said microprocessor.

18. The chromatographic system of claim 17 further comprising a second tee, said second tee being in communication with an outlet port in one of said port pairs of said CS valve and each of said detectors, said second tee dividing said components to each of said at least one detector.

19. The method of using repeated heart cuttings to isolate a component of interest from a complex component using a chromatographic system comprising the steps of:
programming a CS valve within an isothermal oven to an idle state;
programming a 3-way solenoid valve to open an inject valve;
placing a complex component into an inlet in fluid communication with a pre-column within an isothermal oven;
moving said complex component to said pre-column through pressure applied by gas entering through an open gas port in said 3-way solenoid valve;
moving said complex component through said pre-column to an input port in one of multiple port pairs in said CS valve;
moving said complex component from said CS valve through an output port in one of said multiple port pairs to an input of a first column;
moving said CS valve to an active state;
closing said inject valve and opening a backflush valve in said 3-way solenoid;
refocusing said complex component at said first column;
separating lighter molecules to exit at a first column output;
switching said CS valve to an idle state;
connecting said first column output to a second column input;
transferring a slice of said complex sample to said second column;
switching said CS valve to an idle state;
repeating moving said complex sample until a component of interest is isolated.
